(19) United States
(12) Patent Application Publication
(10) Pub. No.: US 2025/0325908 A1
(43) Pub. Date: Oct. 23, 2025

(54) OPERATION METHOD AND APPARATUS FOR VIRTUAL PROP, TERMINAL, AND STORAGE MEDIUM

(71) Applicant: Tencent Technology (Shenzhen) Company Limited, Shenzhen (CN)

(72) Inventors: Ye Kuang, Shenzhen (CN); Haoyang Wu, Shenzhen (CN)

(21) Appl. No.: 19/257,311

(22) Filed: Jul. 1, 2025

Related U.S. Application Data
(63) Continuation of application No. PCT/CN2024/089746, filed on Apr. 25, 2024.

(30) Foreign Application Priority Data
Jun. 15, 2023 (CN) 202310710846.3

(51) Int. Cl. A63F 13/52

(52) U.S. Cl. CPC A63F 13/52

(57) ABSTRACT

Embodiments of this application provide a method for operating a virtual prop in a game performed by a computer device. The method includes: displaying a first virtual object; displaying a batch operation control when a first operation on the first virtual object is received and a quantity of props with which the first virtual object is equipped is greater than a first quantity; and when a second operation on the batch operation control is received and an operation target indicated by the second operation is a second virtual object, transferring the virtual props with which the first virtual object is equipped to the second virtual object. Through the method of the embodiments of this application, a batch operation may be performed on the virtual props, thereby reducing operation costs and improving operation efficiency and fluency.

### CROSS-REFERENCE TO RELATED APPLICATIONS

This application is a continuation application of PCT Patent Application No. PCT/CN2024/089746, entitled “VIDEO ENCODING METHOD AND APPARATUS, ELECTRONIC DEVICE, AND STORAGE MEDIUM” filed on Apr. 25, 2024, which claims priority to Chinese Patent Application No. 202310710846.3, entitled “OPERATION METHOD AND APPARATUS FOR VIRTUAL PROP, TERMINAL, AND STORAGE MEDIUM” filed on Jun. 15, 2023, both of which are incorporated herein by reference in their entirety.

### FIELD OF THE TECHNOLOGY

Embodiments of this application relate to the field of human-computer interaction technologies, and in particular, to an operation method and apparatus for a virtual prop, a terminal, and a storage medium.

### BACKGROUND OF THE DISCLOSURE

To change attributes and skills of a game character, a game player usually wears or removes a virtual prop with which the game character is equipped.

In the related art, to transfer a virtual prop of one game character to another game character, the game player usually needs to select a game character that originally wears the virtual prop, and transfer the virtual prop to the another game character through an operation such as dragging.

However, when the game character wears a plurality of virtual props, efficiency of transferring the virtual props through the foregoing manner is relatively low.

### SUMMARY

Embodiments of this application provide an operation method and apparatus for a virtual prop, a terminal, and a storage medium. The technical solutions are as follows.

According to an aspect, an embodiment of this application provides a method for operating a virtual prop performed by a computer device, and the method including:
displaying a first virtual object;
displaying a batch operation control when a first operation on the first virtual object is received and a quantity of props with which the first virtual object is equipped is greater than a first quantity; and
when a second operation on the batch operation control is received and an operation target indicated by the second operation is a second virtual object, transferring the virtual props with which the first virtual object is equipped to the second virtual object.

According to another aspect, an embodiment of this application provides a computer device including a processor and a memory. The memory has at least one computer instruction stored therein, the at least one computer instruction being executed by the processor to implement the operation method for a virtual prop in the above aspects.

According to another aspect, an embodiment of this application provides a non-transitory computer-readable storage medium, the storage medium having at least one computer instruction stored therein, the at least one computer instruction being executed by a processor to implement the operation method for a virtual prop in the above aspects.

In the embodiments of this application, the batch operation control is added to the virtual object, and the batch operation control is displayed when the first operation for the first virtual object is received and the quantity of props with which the first virtual object is equipped is greater than the first quantity. The virtual prop with which the first virtual object is equipped to the second virtual object when the second operation on the batch operation control is received and the operation target indicated by the second operation is the second virtual object. Through the solutions of this application, the virtual props with which the first virtual object is equipped may be transferred in batches, which reduces operation costs and improves prop transfer efficiency between virtual objects compared with transferring virtual props one by one.

### BRIEF DESCRIPTION OF THE DRAWINGS

FIG. 1 is a schematic diagram of a turn-based chess game according to an exemplary embodiment of this application.

FIG. 2 is a flowchart of an operation method for a virtual prop according to an exemplary embodiment of this application.

FIG. 3 is a schematic diagram of transferring virtual props with which a first virtual object is equipped to a second virtual object in batches through a dragging operation according to an exemplary embodiment of this application.

FIG. 4 is a schematic diagram of dragging a batch operation control corresponding to a first virtual object to an avatar identifier of a second virtual object according to an exemplary embodiment of this application.

FIG. 5 is a schematic diagram of a prop thumbnail control and a prop transfer prompt according to an exemplary embodiment of this application.

FIG. 6 is a schematic diagram of a transfer prohibition prompt according to an exemplary embodiment of this application.

FIG. 7 is a schematic diagram of removing a target virtual prop with which a second virtual object is equipped according to an exemplary embodiment of this application.

FIG. 8 is a schematic diagram of a prop selection bar according to an exemplary embodiment of this application.

FIG. 9 is a schematic diagram of removing a virtual prop with which a first virtual object is equipped through a third operation according to an exemplary embodiment of this application.

FIG. 10 is a schematic diagram of a transfer confirmation prompt according to an exemplary embodiment of this application.

FIG. 11 is a schematic diagram of displaying a prop identifier of a virtual prop and a batch operation control in an object information panel of a first virtual object according to an exemplary embodiment of this application.

FIG. 12 is a schematic diagram of displaying a prop identifier of a virtual prop and a batch operation control on a peripheral side of the first virtual object according to an exemplary embodiment of this application.

FIG. 13 is a flowchart of an operation method for a virtual prop according to an exemplary embodiment of this application.

FIG. 14 is a timing diagram of an operation method for a virtual prop according to an exemplary embodiment of this application.

FIG. 15 is a structural block diagram of an operation apparatus for a virtual prop according to an exemplary embodiment of this application.

FIG. 16 is a schematic structural diagram of a terminal according to an exemplary embodiment of this application.

### DESCRIPTION OF EMBODIMENTS

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. Implementations described in the following exemplary embodiments do not represent all implementations consistent with this application. On the contrary, the implementations are merely examples of an apparatus and a method which are consistent with some aspects of this application described in detail in the attached claims.

The term “several” mentioned herein means one or more, and the term “a plurality of” means two or more. The term “and/or” describes an association relationship between associated objects and indicates that three relationships may exist. For example, A and/or B may indicate the following three cases: only A exists, both A and B exist, and only B exists. The character “/” generally indicates an “or” relationship between the associated objects.

First, terms involved in the embodiments of this application are described.

Turn-based chess game: It refers to a chess game in which “chess pieces” are pre-arranged before a chess battle, and during the battle, the “chess pieces” can automatically play against each other according to the pre-arrangement. The “chess pieces” are usually represented by virtual characters. During the battle, the virtual characters automatically release various skills to battle. Battles are usually turn-based. When all “chess pieces” of one side in the battle are killed (i.e., a hit point of the virtual character is reduced to zero), this side is a defeated side of the battle of the current turn. In some embodiments, in addition to having “chess piece-type virtual characters” for playing a game, two sides of a battle also have virtual characters representing users participating in the battle. The virtual character cannot be moved to a combat area or a preparation area as a “chess piece”. The virtual character is also provided with a hit point (or a blood volume). The hit point of the virtual character is reduced (the battle fails) or stays unchanged (the battle succeeds) based on a result of each battle. When the hit point of the virtual character is reduced to zero, the user corresponding to the virtual character exits the battle, and the remaining user continues to battle. In some embodiments, the turn-based chess games include an auto chess.

Auto chess: It is a turn-based chess game, and is an eight-player turn-based competitive game of an intra-episode hero card. Each turn includes two stages: a preparation stage and a combat stage. In the preparation stage, a user purchases chess pieces (heroes) in a store and makes a deployment on a chessboard. In the combat stage, lineups of both sides are locked, and the chess pieces automatically engage in a battle until all chess pieces of one side are killed or a turn duration is reached. A player whose chess pieces are all killed is the defeated side of the current turn, and a specific amount of blood volume is deducted. Game turns are continuously repeated and new opponents are matched until the hit point of a player is ≤0 and the player is eliminated. A last remaining player finally wins the game (ranking the 1^{st} place). Rankings (the 2^{nd} place to the 8th place) of other players are determined based on an elimination order and the remaining hit points thereof when being eliminated.

Chessboard: It refers to an area in a battle interface of a turn-based chess game configured for preparing for and conduct battles. The chessboard can be any one of a two-dimensional virtual chessboard, a 2.5-dimensional virtual chessboard, and a three-dimensional virtual chessboard, which is not limited in this application.

Chess piece: It refers to a virtual object placed on a chessboard in a turn-based chess game, including a combat chess piece, a preparation chess piece, and a chess piece sold in a store. The combat chess piece includes a chess piece located in a combat area, the preparation chess piece includes a chess piece located in the preparation area, and the chess piece sold in the store is added to the preparation area upon a purchase, and becomes the preparation chess piece. The chess piece may be a virtual character, a virtual chess piece, a virtual character, a virtual animal, an animation character, and the like. The chess pieces can be displayed through a three-dimensional model.

In some embodiments, a position of the combat chess piece on a chessboard can be changed. In the preparation stage, a user can adjust the position of the chess piece in the combat area, move the chess piece located in the combat area to the preparation area (when an idle position for a candidate chess piece exists in the preparation area), or move the chess piece located in the preparation area to the combat area. In the combat stage, the position of the chess piece located in the preparation area can also be adjusted.

In some embodiments, in the combat stage, the position of the chess piece in the combat area differs from that in the preparation stage. In the combat stage, a game application automatically controls the chess piece in the combat area to move and battle in the combat area. For example, in the combat stage, the chess piece can automatically move from an allied combat area to an enemy combat area and attack a chess piece of the enemy. Alternatively, the chess piece can automatically move from a position A in the allied combat area to a position B in the allied combat area.

Additionally, in the preparation stage, chess pieces can only be set in the allied combat area (an allied deployment area).

Regarding a method for obtaining the combat chess piece, in some embodiments, the user can purchase a chess piece in a store with a gold coin in the preparation stage during a battle.

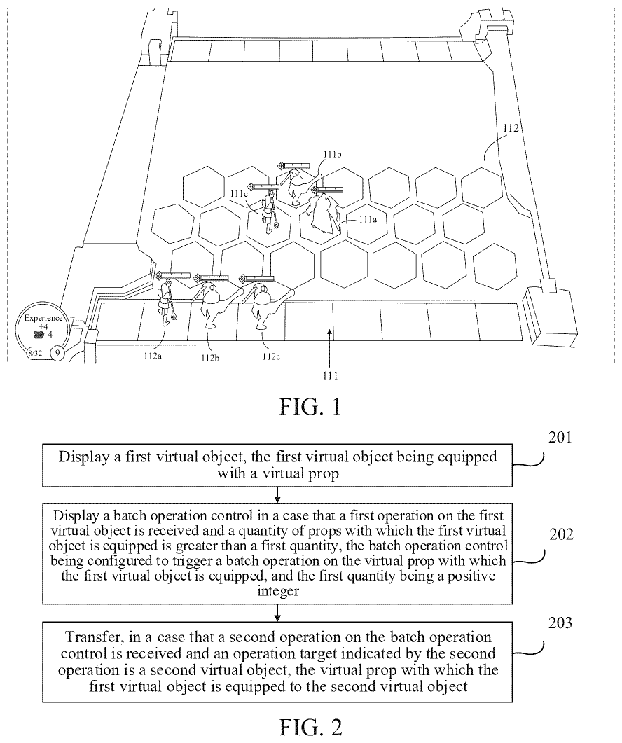

As shown in FIG. 1, a first combat chess piece 111a, a second combat chess piece 111b, and a third combat chess piece 111c are displayed in a combat area 112, and a first preparation chess piece 112a, a second preparation chess piece 112b, and a third preparation chess piece 112c are displayed in a preparation area 111.

Virtual prop: In a turn-based chess game, a chess piece can be equipped with one or more virtual props. In some embodiments, the virtual prop includes a plurality of virtual prop types. For example, the virtual prop may include different virtual prop types such as a virtual prop of clothes, a virtual prop of shoes, and a virtual prop of a weapon. Each virtual prop type may include a plurality of different virtual props. For example, a virtual prop of a weapon may include a plurality of different virtual props such as an attack claw, a broad sword, a crystal sword, a short stick, a marking gun, and a sword.

In some embodiments, different types of virtual objects and virtual props may have different matching degrees. For example, for a wizard-type virtual object, a wizard-type virtual prop such as a magic crystal and a wizard has a relatively high degree of matching with the wizard, and physical-type virtual props such as a dagger and an arrow have a relatively low degree of matching with the wizard.

Attribute: Each chess piece in a turn-based chess game has an attribute, and the attribute includes at least two of the following attributes: a camp of a chess piece (for example, an alliance A, an alliance B, and a neutral faction), a type of a chess piece (for example, a warrior, a shooter, a master, an assassin, a guard, a swordsman, a gunner, and a fighter), an attack type of a chess piece (for example, a spell attack and a physical attack), an identity of a chess piece (for example, a noble, a demon, and a fairy), and the like. In the embodiments of this application, specific types of attributes are not limited. In some embodiments, the virtual prop provided by each chess piece may change the attribute of the chess piece.

With reference to the foregoing description of the turn-based chess game, this embodiment of this application is described by using an example in which the game type is the turn-based chess game. However, the method in this embodiment of this application may further be applied to another game having a requirement for transferring an equipment between virtual objects, for example, to a game in which the equipment can be transferred between different virtual characters, such as a role-playing game (RPG) or a first-person shooting game (FPS). Types of the games are not limited in this embodiment of this application.

In a game process, to transfer a virtual prop equipped with one virtual object to another virtual object, a game player usually needs to select a virtual object originally equipped with the virtual prop and perform an operation such as a dragging operation to move an equipment icon corresponding to the virtual prop to another virtual object, so as to transfer the virtual prop to another virtual object.

However, when the virtual object is equipped with a plurality of virtual props, efficiency of transferring the virtual props through the foregoing manner is relatively low.

This application provides an operation method for a virtual prop for performing a batch operation on a plurality of virtual props, which can implement a batch transfer operation on the virtual props with which the virtual object is equipped, thereby reducing operation costs and improves operation efficiency and fluency.

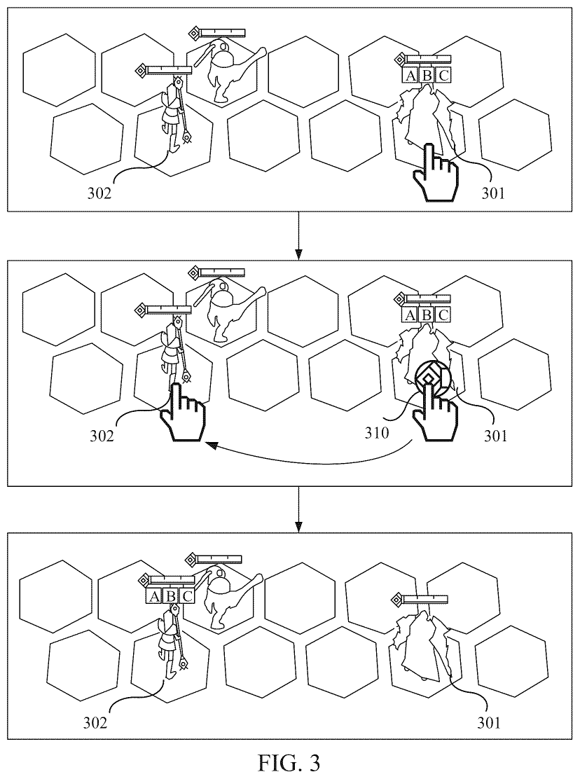

FIG. 2 is a flowchart of an operation method for a virtual prop according to an exemplary embodiment of this application. This embodiment is described by using an example in which the method is performed by a terminal. The flowchart includes the following operations.

Operation 201: Display a first virtual object, the first virtual object being equipped with virtual props.

In some embodiments, the first virtual object may be a virtual character, a virtual chess piece, a virtual character, a virtual animal, an animation character, and the like. The first virtual object may be displayed through a three-dimensional model.

In some embodiments, the first virtual object a chess piece placed on a chessboard, including a combat chess piece, a preparation chess piece, and a chess piece sold in a store.

In some embodiments, the first virtual object may have a virtual object type, for example, a virtual object type such as a warrior, a shooter, a master, an assassin, a guard, a swordsman, a gunner, and a fighter.

In some embodiments, the first virtual object is simultaneously equipped with two or more virtual props. For example, the first virtual object may be simultaneously equipped with 2 virtual props, namely a void staff and a guardian angel.

The virtual prop is one or more types of equipment that the virtual object may equip.

In some embodiments, the virtual prop includes a plurality of virtual prop types. For example, the virtual prop may include different virtual prop types such as a virtual prop of clothes, a virtual prop of shoes, and a virtual prop of a weapon.

For example, each virtual prop type may include a plurality of different virtual props. For example, a virtual prop of a weapon may include a plurality of different virtual props such as an attack claw, a broad sword, a crystal sword, a demon edge, a quarterstaff, a javelin, a golden cudgel, and a divine rapier.

Operation 202: Display a batch operation control when a first operation on the first virtual object is received and a quantity of props with which the first virtual object is equipped is greater than a first quantity, the batch operation control being configured to trigger a batch operation on the virtual prop with which the first virtual object is equipped, and the first quantity being a positive integer.

The first operation is an operation configured for triggering display of a batch operation control corresponding to the virtual object. In some embodiments, the first operation is a prediction operation on an application. Alternatively, the first operation may be a customized operation.

In some embodiments, the first operation may be a touching and holding operation, a clicking/tapping operation, a double-clicking operation, or a pressing operation on the first virtual object, which is not limited in the embodiments of this application. For example, when a game player selects the first virtual object through touching and holding by a mouse cursor or a finger, the terminal determines that the first operation on the first virtual object is received.

The quantity of props with which the first virtual object is equipped is a sum of all virtual props the first virtual object is equipped with. For example, if all virtual prop with which the first virtual object is equipped are the void staff and the guardian angel, the quantity of props with which the first virtual object is equipped is 2.

In some embodiments, the quantity of equipped props has an upper limit. For example, in some games, each virtual object is equipped with no more than 3 virtual props.

The first quantity is a quantity threshold for triggering to perform a batch operation on the virtual prop. The first quantity is a positive integer. In some embodiments, the first quantity is 1. In a case that the quantity of props with which the first virtual object is equipped is greater than 1, the terminal displays the batch operation control based on the first operation. For example, when an upper limit of the virtual props with which the virtual object is equipped is 3 and the first quantity is 1, if the first operation on the first virtual object is received when the first virtual object is equipped with 2 or 3 virtual props, the terminal displays the batch operation control.

In some embodiments, the first quantity may be a preset value of an application and does not support modification. In some other embodiments, the first quantity may be customized by a user.

In some embodiments, the batch operation control may be located on a peripheral side of the first virtual object, or located in an object information panel corresponding to the first virtual object. The object information panel is configured to display object information of the first virtual object, including an attribute value, a level, a prop equipment condition, and the like.

Operation 203: Transfer, when a second operation on the batch operation control is received and an operation target indicated by the second operation is a second virtual object, the virtual prop with which the first virtual object is equipped to the second virtual object.

The second operation is an operation for the batch operation control and configured to trigger a batch transfer of the virtual props.

In some embodiments, the second operation is a dragging operation performed by a game player on the batch operation control. For example, the game player drags the batch operation control to a position of the second virtual object through touching by the mouse cursor or the finger.

In some embodiments, an operation target indicated by the second operation is a position at which the touch of the mouse cursor or the finger of the game player is located when the second operation ends. For example, the operation target may be the second virtual object, a blank position, the first virtual object, a non-player character (NPC), and the like.

In some embodiments, the second virtual object is another virtual object belonging to the same camp as the first virtual object.

In some embodiments, the quantity of props with which the second virtual object is equipped may be zero or greater than zero. In other words, the second virtual object may either have not be equipped with the virtual prop or may be equipped with one or more virtual props.

In some embodiments, the second virtual object may be a virtual character located in a preparation area, or a virtual character located in a combat area.

In some embodiments, before the virtual prop with which the first virtual object is quipped is transferred to the second virtual object, the virtual prop with which the first virtual object is equipped or the second virtual object may need to be removed through a disposable virtual prop such as a detacher. In other words, the detacher needs to be consumed. In some other embodiments, the virtual prop with which the first virtual object is equipped may be transferred to the second virtual object in batches directly based on the second operation on the batch operation control without using the disposable virtual prop such as the detacher.

In some embodiments, the transfer of the virtual prop from the first virtual object to the second virtual object may be performed during the preparation stage. In some embodiments, the first virtual object and second virtual object may both be the virtual objects located in the combat area. Alternatively, the first virtual object and second virtual object may both be virtual objects located in the preparation area. Alternatively, one of the first virtual object and the second virtual object is located in the preparation area, while the other is located in the combat area.

In some other embodiments, the transfer of the virtual prop from the first virtual object to the second virtual object may be performed during the combat stage. In some embodiments, the first virtual object and the second virtual object may both be virtual objects located in the preparation area. Alternatively, the first virtual object may be the virtual object located in the preparation area, and the second virtual object may be the virtual object located in the combat area (i.e., a prop of a chess piece in the preparation area is transferred to a chess piece in the combat area, to improve an attribute of the chess piece in the combat area).

Based on the above, the batch operation control is added to the virtual object, and the batch operation control is displayed when the first operation for the first virtual object is received and the quantity of props with which the first virtual object is equipped is greater than the first quantity. The virtual prop with which the first virtual object is equipped is transferred to the second virtual object when the second operation on the batch operation control is received and the operation target indicated by the second operation is the second virtual object. Through the solutions of this application, the virtual props with which the first virtual object is equipped may be transferred in batches, which reduces operation costs and improves prop transfer efficiency between virtual objects compared with transferring virtual props one by one.

To transfer the virtual prop with which the first virtual object is equipped to the second virtual object in batches, in some embodiments, the second operation is a dragging operation.

FIG. 3 is a schematic diagram of transferring virtual props with which a first virtual object is equipped to a second virtual object in batches through a dragging operation according to an exemplary embodiment of this application.

As shown in FIG. 3, a corresponding game interface diagram before the dragging operation has a first virtual object 301 and a second virtual object 302. For example, the first virtual object 301 is equipped with 3 types of virtual props, which are respectively a virtual prop A, a virtual prop B, and a virtual prop C. Therefore, a quantity of props with which the first virtual object 301 is equipped is 3. In a case that the first operation (such as a touching and holding operation) on the first virtual object 301 is received, and the quantity of props with which the first virtual object 301 is equipped is greater than a first quantity (assuming to be 1), a batch operation control 310 is displayed (referring to the corresponding game interface diagram in the dragging operation).

In a case that a dragging operation on the batch operation control 310 is received and a dragging end point of the dragging operation is located on the second virtual object 302, the terminal transfers the virtual prop with which the first virtual object 301 is equipped to the second virtual object 302. In other words, the 3 types of virtual prop with which the first virtual object is equipped 301 are transferred to the second virtual object 302 in batches, and the first virtual object 301 is no longer equipped with the virtual props.

To reduce a dragging distance of the dragging operation and further improve efficiency of transferring the virtual props in batches, in some embodiments, the batch operation control corresponding to the first virtual object may be dragged to an avatar identifier of the second virtual object, so as to transfer the virtual props of the first virtual object to the second virtual object in batches.

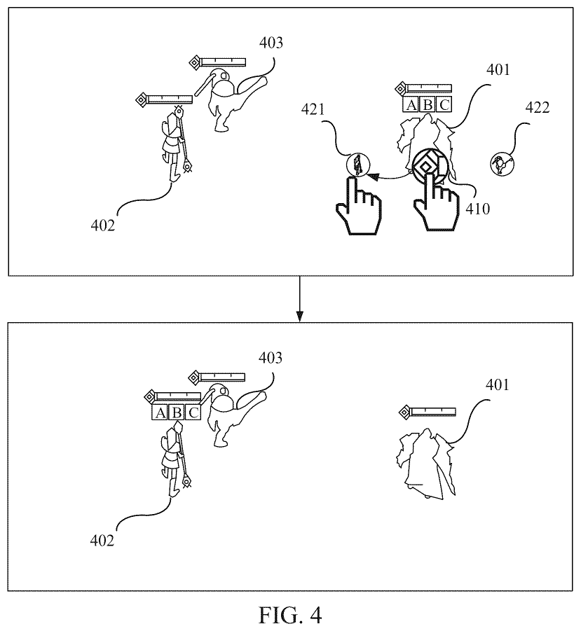

FIG. 4 is a schematic diagram of dragging a batch operation control corresponding to a first virtual object to an avatar identifier of a second virtual object according to an exemplary embodiment of this application.

As shown in FIG. 4, a game player intends to transfer a virtual prop of a first virtual object 401 to a second virtual object 402 in batches. To reduce a dragging distance, a terminal may display an avatar identifier 421 corresponding to the second virtual object 402 on a peripheral side of a batch operation control 410 on a game interface. When the game player drags the batch operation control 410 to the avatar identifier 421 through touching by a mouse cursor or a finger, the virtual prop of the first virtual object 401 is transferred to the second virtual object 402 in batches. The game player does not need to drag, by using a long-range dragging operation, the batch operation control 410 to a position of the second virtual object 402, which achieves an effect of improving operation efficiency.

Similarly, the terminal may display an avatar identifier 422 corresponding to a third virtual object 403 on a peripheral side of the batch operation control 410 on the game interface for the game player to select. That the game player intends to transfer the virtual prop of the first virtual object 401 to the third virtual object 403 in batches may be implemented by dragging the batch operation control 410 to the avatar identifier 422.

In this embodiment, the avatar identifier of the second virtual object is displayed on the peripheral side of the batch operation control, so that the dragging distance of the dragging operation during batch transfer of dragging may be shortened, which further improves efficiency of transferring the virtual props in batches.

In a dragging operation process, to indicate to the game player that the virtual props are being transferred in batches, the terminal may display a prop thumbnail control or a prop transfer prompt on the game interface.

In some embodiments, before transferring the virtual prop with which the first virtual object is equipped to the second virtual object, the terminal changes the batch operation control into the prop thumbnail control when the dragging operation on the batch operation control is received.

The prop thumbnail control is a control configured to indicate that the virtual prop is being transferred in the dragging operation process.

In some embodiments, the prop thumbnail identifier of the virtual prop with which the first virtual object is equipped is displayed in the prop thumbnail control, and the prop thumbnail control moves with the dragging operation.

In some embodiments, the prop thumbnail identifier is a thumbnail image identifier or text identifier of the virtual prop with which the first virtual object is equipped.

In some embodiments, when receiving the dragging operation on the batch operation control from the game player, the terminal immediately changes the batch operation control into the prop thumbnail control for displaying.

In some embodiments, when a dragging position of the dragging operation is located on the second virtual object, the terminal displays a prop transfer prompt, to prompt the game player to end an effect generated by the dragging operation on the dragging position.

In some embodiments, a first object identifier of the first virtual object, a second object identifier of the second virtual object, and the prop thumbnail identifier are included in the prop transfer prompt.

The first object identifier is configured to represent an initial equipment party of a virtual prop in a virtual prop transfer process, namely, a transferor of the virtual prop.

In some embodiments, the first object identifier may be an avatar, a thumbnail, or the like of the first virtual object.

The second object identifier is configured to represent a to-be-equipped party of a virtual prop in a virtual prop transfer process, namely, a transferee of the virtual prop.

In some embodiments, the second object identifier may be an avatar, a thumbnail, or the like of the second virtual object.

The prop thumbnail identifier is configured to represent all or part of the virtual props involved in the virtual prop transfer process. In some embodiments, the prop thumbnail identifier may be a thumbnail image, text, or the like corresponding to the virtual prop.

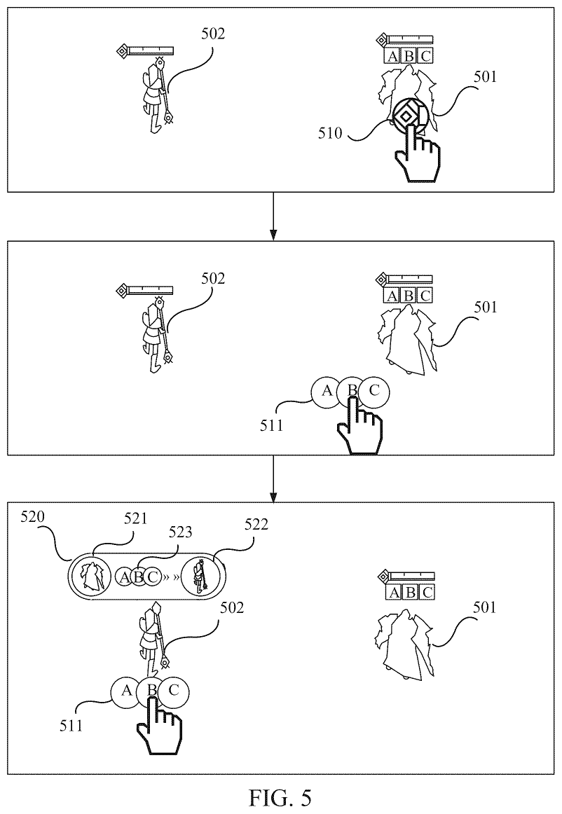

FIG. 5 is a schematic diagram of a prop thumbnail control and a prop transfer prompt according to an exemplary embodiment of this application.

As shown in FIG. 5, a game player intends to transfer 3 types of virtual props (a virtual prop A, a virtual prop B, and a virtual prop C) on a first virtual object 501 to a second virtual object 502.

In a case that a first operation (such as a touching and holding operation) for the first virtual object 501 is received and a quantity of props that the first virtual object 501 is equipped with is greater than a first quantity (assuming to be 1), a batch operation control 510 is displayed.

In a case that a dragging operation on the batch operation control 510 is received, a terminal changes the batch operation control 510 in the game interface to a prop thumbnail control 511. The prop thumbnail control 511 displays prop thumbnail identifiers of the virtual props with which the first virtual object is equipped 501 is equipped, for example, prop thumbnail identifiers corresponding to the virtual prop A, the virtual prop B, and the virtual prop C. In addition, the prop thumbnail control 511 may move along with the dragging operation, to prompt the game player that the dragging operation of virtual prop transfer is being performed.

In a case that a dragging position of the dragging operation is located on the second virtual object 502, the terminal displays a prop transfer prompt 520 in the game interface, to prompt the game player that the virtual prop of the first virtual object 501 is to be transferred to the second virtual object 502.

In some embodiments, the prop transfer prompt 520 is located on a top or a peripheral side of the second virtual object 502.

In some embodiments, a first object identifier 521 of the first virtual object 501, a second object identifier 522 of the second virtual object 502, and a prop thumbnail identifier 523 are included in the prop transfer prompt 520.

The first object identifier 521 is configured to indicate the virtual object transferring the virtual props. In some embodiments, the first object identifier 521 may be an avatar, a thumbnail, or the like of the first virtual object 501.

The second object identifier 522 is configured to indicate a transfer object of the virtual prop. In some embodiments, the second object identifier 522 may be an avatar, a thumbnail, or the like of the second virtual object 502.

The prop thumbnail identifier 523 is configured for indicating a transferred virtual prop. In some embodiments, the prop thumbnail identifier 523 includes thumbnails corresponding to the virtual prop A, the virtual prop B, and the virtual prop C.

In this embodiment, when the dragging operation is received, the batch operation control is changed to the prop thumbnail control, and the prop thumbnail control moves with the dragging operation, to intuitively and clearly present the virtual prop that is being transferred to the game player. In a case that a dragging position of the dragging operation is located on the second virtual object, the prop transfer prompt is displayed. The prop transfer prompt includes the first object identifier of the first virtual object, the second object identifier of the second virtual object, and the prop thumbnail identifier, so that the virtual prop being transferred and a related virtual object may be intuitively and clearly presented to the game player, which avoids a case in which the virtual prop is mistakenly transferred to another virtual object except the second virtual object, thereby improving accuracy of transferring the virtual prop.

In a possible scenario, when the dragging position of the dragging operation is located in the second virtual object and the second virtual object is supported in equipping the virtual prop, the terminal may display the prop transfer prompt in the game interface.

In another possible scenario, the second virtual object may not support a virtual prop with which the first virtual object is equipped. For example, a role type of the second virtual object cannot be equipped with the virtual prop (for example, the second virtual object is an NPC), or a role level of the second virtual object does not meet a level condition for equipping the virtual prop.

Therefore, when the second virtual object is not supported in equipping the virtual prop, the terminal may display a transfer prohibition prompt.

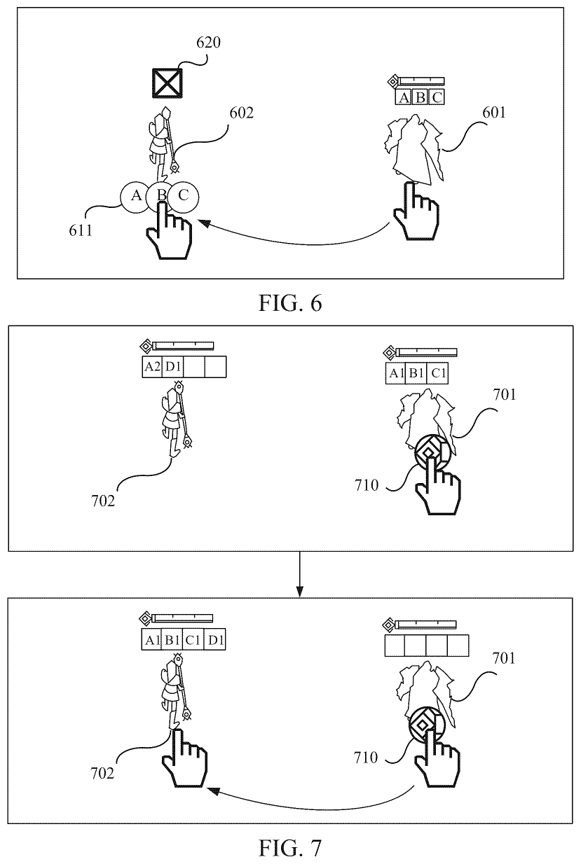

FIG. 6 is a schematic diagram of a transfer prohibition prompt according to an exemplary embodiment of this application.

As shown in FIG. 6, a game player intends to transfer a virtual prop of a first virtual object 601 to a second virtual object 602 in batches through a dragging operation.

In a dragging process, the batch operation control (not shown) is changed to a prop thumbnail control 611.

In a case that a dragging position of the dragging operation is located on the second virtual object 602 and the second virtual object 602 is not supported in equipping the virtual prop, a transfer prohibition prompt 620 is displayed, to prompt a user that the second virtual object 602 is not supported in equipping the virtual prop, and preparation for virtual transfer cannot be performed.

In a process of performing virtual prop batch transfer, the batch transfer may need to be canceled for some reasons. For example, when a virtual prop with which the first virtual object is equipped in a preparation area needs to be transferred to the second virtual object in a combat area in a battle process, but the second virtual object is about to be or has been defeated in a process of performing a transfer operation, a player needs to terminate the batch transfer. To help quickly cancel the batch transfer in such a scenario, in some embodiments, when the dragging operation for the batch operation control is received, and no virtual object exists at a dragging end point of the dragging operation, the terminal keeps the virtual prop with which the first virtual object is equipped.

In addition to keeping the virtual prop with which the first virtual object is equipped when no virtual object exists at the dragging end point, in some other embodiments, the terminal keeps the virtual prop with which the first virtual object is equipped when the dragging operation for the batch operation control is received and the virtual object at the dragging end point of the dragging operation is not supported in equipping the virtual prop.

For example, when a position of the dragging end point of the dragging operation is located on the second virtual object 602 and the second virtual object 602 is not supported in equipping the virtual prop, a virtual prop A, a virtual prop B, and a virtual prop C of the first virtual object 601 are kept.

When the game player intends to transfer the virtual prop of the first virtual object to the second virtual object in batches, the second virtual object may already be equipped with the virtual prop. Therefore, in some embodiments, the virtual prop of the second virtual object needs to be removed first.

In a possible design, when the second virtual object is equipped with the virtual prop, the terminal needs to remove the virtual prop of the second virtual object.

In another possible design, when the second virtual object is equipped with the virtual prop and the second virtual object cannot be equipped with a to-be-transferred virtual prop of the first virtual object while keeping equipped with the virtual prop, the terminal needs to remove the virtual prop of the second virtual object.

In some embodiments, when the second virtual object is equipped with the virtual prop, the terminal removes a target virtual prop with which the second virtual object is equipped based on the virtual prop with which the first virtual object is equipped and the second virtual object.

In some embodiments, when the second virtual object is equipped with the virtual prop, and a sum of a quantity of props with which the second virtual object is equipped and a quantity of props with which the first virtual object is equipped is greater than an upper limit of the props with which the second virtual object is equipped, the terminal removes the target virtual prop with which the second virtual object is equipped based on the virtual prop with which the first virtual object is equipped and the second virtual object.

In a case that the second virtual object is equipped with the virtual prop, and a sum of a quantity of props with which the second virtual object is equipped and a quantity of props with which the first virtual object is equipped is less than or equal to an upper limit of the props with which the second virtual object is equipped, the terminal determines the target virtual prop with which the second virtual object is equipped does not need to be removed. In a schematic example, the upper limit of the props with which the second virtual object is equipped is 3. When the first virtual object is equipped with 2 virtual props and the second virtual object is equipped with 2 virtual props, the terminal needs to determine a to-be-removed target virtual prop. When the first virtual object is equipped with 2 virtual props and the second virtual object is equipped with 1 virtual prop, the terminal does not need to determine the to-be-removed target virtual prop.

The target virtual prop is a virtual prop that the second virtual object needs to remove.

Regarding a manner of determining the target virtual prop, in some embodiments, when the first virtual object and the second virtual object are both equipped with a virtual prop of a target type, the terminal determines the virtual prop of the target type with which the second virtual object is equipped as the target virtual prop.

In some embodiments, the terminal obtains the quantity of props with which the second virtual object is equipped. If the quantity of props with which the second virtual object is equipped is zero, it is determined that the second virtual object has no target virtual prop. If the quantity of props with which the second virtual object is equipped is greater than zero, the terminal obtains a virtual prop type of the virtual prop with which the second virtual object is equipped and a virtual prop type of the virtual prop with which the first virtual object is equipped.

In a case that the virtual prop type of the second virtual object overlaps the virtual prop type of the first virtual object, the terminal uses the virtual prop type as the target type, and determines the virtual prop of the target type of the second virtual object as the target virtual prop for removing.

In some embodiments, the terminal can automatically place the removed target virtual props into a backpack.

In some other embodiments, the terminal may further automatically transfer the removed target virtual prop to the first virtual object.

FIG. 7 is a schematic diagram of removing a target virtual prop with which a second virtual object is equipped according to an exemplary embodiment of this application.

As shown in FIG. 7, a game player intends to transfer a virtual prop of a first virtual object 701 to a second virtual object 702 in batches. Before a dragging operation is performed on the batch operation control 710, the first virtual object 701 is equipped with a virtual prop A1, a virtual prop B1, and a virtual prop C1, and the second virtual object 702 is equipped with a virtual prop A2 and a virtual prop D1.

A letter number of a virtual prop indicates a type of the virtual prop, different virtual props with the same letter number have the same type, and different virtual props with different letter numbers have different types. For example, the virtual prop A1 is a crystal sword, and the virtual prop A2 is a divine rapier, which are both virtual props of weapons. The virtual prop B1 is a magic wand shoe, and is a virtual prop of clothing. The virtual prop C1 is a vanguard shield, and is a virtual prop for protection. The virtual prop D1 is a medallion of courage, and is auxiliary virtual prop. Therefore, the virtual prop B1, the virtual prop C1, and the virtual prop D1 belong to different types.

A terminal obtains that a quantity of props with which the second virtual object 702 is equipped is 2, and is a positive integer greater than zero. Therefore, the obtained virtual prop type of the second virtual object 702 is a virtual prop of a weapon and an auxiliary virtual prop, and the obtained virtual prop type of the first virtual object 701 is a virtual prop of a weapon, a virtual prop of clothing, and a virtual prop for protection. In other words, the first virtual object 701 and the second virtual object 702 both have the virtual prop of a weapon. Therefore, the terminal uses the virtual prop of a weapon as a target type, determines the virtual prop A2 with which the second virtual object 702 is equipped as a target virtual prop, and removes the virtual prop A2.

In some embodiments, the terminal automatically removes the virtual prop A2 through a detacher, and automatically puts the virtual prop A2 back into a backpack.

After the virtual prop A2 equipped with the second virtual object 702 is removed, the first virtual object 701 and the second virtual object 702 are no longer equipped with the same type of virtual prop. After the dragging operation is performed on the batch operation control 710, the second virtual object 702 is equipped with the virtual prop A1, the virtual prop B1, the virtual prop C1, and the virtual prop D1, and the first virtual object 701 is no longer equipped with the virtual prop.

In this embodiment, the virtual prop of the target type with which the second virtual object is equipped as the target virtual prop and the target virtual prop is removed, so that the same type of virtual prop conflict may be avoided when the first virtual object and the second virtual object equipment are both equipped with the target type of virtual prop, thereby improving accuracy of a batch transfer of the virtual props.

In another method for determining the target virtual prop, the terminal determines the target virtual prop needing to be removed based on a sequence of the virtual prop with which the second virtual object is equipped in an equipment bar. In some embodiments, when the virtual prop in the equipment bar is equipped along a first direction, the terminal determines the target virtual prop along a second direction, or the terminal determines the target virtual prop along the first direction. The second direction is opposite to the first direction.

For example, when an upper limit of the quantity of props with which the second virtual object is equipped is 3 and the virtual prop is equipped, the virtual prop is sequentially filled into the equipment bar based on a sequence of left, middle, and right. The first direction is from left to right.

When a total quantity of virtual props with which the second virtual object and the first virtual prop are equipped is greater than the upper limit of the quantity of props, the terminal determines the target virtual prop needing to be removed (i.e., priority is given to removing a virtual prop equipped later) based on a sequence of middle-to-left (i.e., the second direction is from right to left), or the terminal determines the target virtual prop needing to be removed based on a sequence (i.e., the second direction) of middle-to-left (i.e., priority is given to removing a virtual prop equipped earlier).

For example, when the first virtual object is equipped with virtual props A, B, and C and the second virtual object is equipped with virtual props E and F, the target virtual props that need to be removed by the second virtual object is the virtual props E and F and the second virtual object is finally equipped with the virtual props A, B, and C when the virtual props with which the first virtual object is equipped are transferred to the second virtual object in batches. Further, when the removed target virtual props are transferred to the first virtual object, the first virtual object is finally equipped with the virtual props E and F.

For another example, when the first virtual object is equipped with the virtual props A and B, the second virtual object is equipped with the virtual props C and D, the first direction is from left to right, and the second direction is from right to left, the target virtual prop that needs to be removed by the second virtual object is the virtual prop D and the second virtual object is finally equipped with the virtual props A, B, and C when the virtual props with which the first virtual object is equipped are transferred to the second virtual object in batches. Further, when the removed target virtual prop is transferred to the first virtual object, the first virtual object is finally equipped with the virtual prop D.

In a process of transferring the virtual prop from the first virtual object to the second virtual object in batches, the game player may need to manually adjust a transfer status of some virtual props in consideration of a battle policy. For example, only some virtual props of the first virtual object are transferred to the second virtual object. Therefore, in some embodiments, the terminal may display a prop selection bar in the game interface when the second virtual object is equipped with the virtual prop, for a game player to manually adjust the virtual prop that needs to be transferred.

In some embodiments, before the virtual prop with which the first virtual object is transferred to the second virtual object, the terminal may further display the prop selection bar when the second virtual object is equipped with the virtual prop.

The displayed prop selection bar is a toolbar used by the game player to select a virtual prop.

In some embodiments, the displayed prop selection bar is located on a peripheral side of the second virtual object.

In some embodiments, the prop selection bar includes a first prop region and a second prop region. The first prop region is configured to display a to-be-removed virtual prop, the second prop region is configured to display a virtual prop with which the second virtual object is to be equipped, and the virtual props with which the first virtual object and the second virtual object are equipped are initially displayed in the second prop region.

In some embodiments, when a transfer confirmation operation is received, the virtual prop displayed in the second prop region is a virtual prop with which the second virtual object is equipped finally after the prop transfer is completed. The transfer confirmation operation may be triggered by a confirmation control in the prop selection bar.

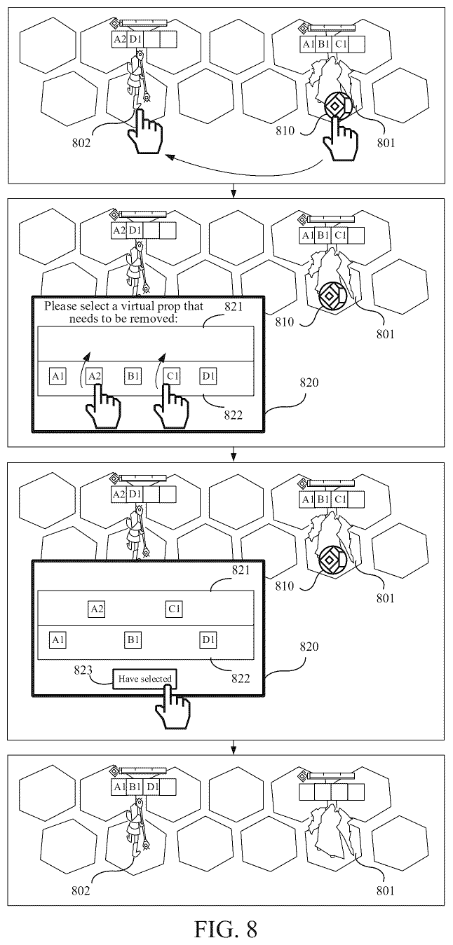

FIG. 8 is a schematic diagram of a prop selection bar according to an exemplary embodiment of this application.

As shown in FIG. 8, a game player intends to transfer a virtual prop of a first virtual object 801 to a second virtual object 802 in batches. In some embodiments, the terminal may trigger, based on a specific trigger operation, displaying a prop selection bar 820 on a game interface. For example, when a dragging end point of the dragging operation is located on the second virtual object 802, the terminal displays the prop selection bar 820. In some embodiments, the terminal may further trigger displaying of the prop selection bar 820 based on another manner. For example, when a sliding-up operation or a double-clicking operation performed by the game player on the batch operation control 810 is received, the terminal displays the prop selection bar 820 on the game interface, which is not limited in this embodiment of this application.

The prop selection bar 820 includes a first prop region 821 and a second prop region 822. The first prop region 821 is configured to display a to-be-removed virtual prop, the second prop region 822 is configured to display a virtual prop with which the second virtual object 802 is to be equipped, and the virtual props with which the first virtual object 801 and the second virtual object 802 are equipped are initially displayed in the second prop region 822.

As shown in FIG. 8, before an adjustment operation, the first prop region 821 is initially displayed as empty, and the second prop region 822 is initially displayed with all virtual props with which the first virtual object 801 and the second virtual object 802 are equipped, including virtual props A1, A2, B1, C1, and D1.

The prop selection bar 820 includes words of “Please select a virtual prop that needs to be removed” to prompt the game player to perform an adjustment operation on virtual props in the first prop region 821 and the second prop region 822. For example, the game player moves the virtual props A2 and C1 in the second prop region 822 to the first prop region 821 under guidance of the prompt information, representing that the virtual props A2 and C1 belong to the to-be-removed virtual props.

After selecting a virtual prop that needs to be removed, the game player clicks/taps a confirmation control 823 of “Have selected”. The terminal determines the virtual prop with which the second virtual object is to be equipped in response to an adjustment operation performed by the game player on the virtual props in the first prop region and the second prop region. For example, the terminal may determine remaining virtual props A1, B1, and D1 in the second prop region 822 after the adjustment operation as virtual props with which the second virtual object 802 is to be equipped.

Because the virtual prop with which the second virtual object is to be equipped may include a part of the virtual prop with which the second virtual object is currently equipped and a part of the virtual prop with which the first virtual object is currently equipped, when the prop transfer is performed, only the part of the virtual prop with which the first virtual object is currently equipped needs to be removed, and the part of the virtual prop with which the second virtual object is currently equipped is reserved. Therefore, the terminal determines, based on the virtual prop with which the second virtual object is to be equipped, the first virtual object, and the virtual prop with which the second virtual object is currently equipped, a to-be-removed virtual prop corresponding to the second virtual object and a to-be-transferred virtual prop corresponding to the first virtual object.

In some embodiments, the terminal determines an intersection set of the virtual prop with which the second virtual object is to be equipped and the virtual prop with which the first virtual object is currently equipped as the to-be-transferred virtual prop corresponding to the first virtual object. For example, when the virtual prop with which the second virtual object is to be equipped is S1 and the virtual prop with which the first virtual object is currently equipped is S2, the to-be-transferred virtual prop corresponding to the first virtual object is S1∩S2.

In some embodiments, the terminal determines an intersection set of the virtual prop with which the second virtual object is to be equipped and the virtual prop with which the second virtual object is currently equipped, and determines a virtual prop outside the intersection set in the virtual prop with which the second virtual object is currently equipped as the to-be-removed virtual prop corresponding to the second virtual prop. For example, when the virtual prop with which the second virtual object is to be equipped is S1 and the virtual prop with which the second virtual object is currently equipped is S3, the to-be-removed virtual prop corresponding to the second virtual object is S3−(S1∩S3). For example, the terminal may determine, based on the virtual props A1, B1, and D1 with which the second virtual object is to be equipped, the virtual props A1, B1, and C1 with which the first virtual object is currently equipped, and the virtual props A2 and D1 with which the second virtual object is currently equipped, that the to-be-removed virtual prop corresponding to the second virtual object 802 is the virtual prop A2, and the to-be-transferred virtual prop corresponding to the first virtual object 801 is the virtual props A1 and B1.

In some embodiments, the terminal automatically removes the to-be-removed virtual prop corresponding to the second virtual object. For example, the terminal automatically returns the to-be-removed virtual prop A2 to a backpack.

After a dragging operation is performed on the batch operation control 810, the to-be-transferred virtual props A1 and B1 corresponding to the first virtual object 801 are transferred to the second virtual object 802. The terminal automatically returns the remaining to-be-removed virtual prop C1 to the backpack. The first virtual object 801 is no longer equipped with the virtual prop.

Regarding a processing manner of the to-be-removed virtual prop, in some embodiments, the terminal may automatically return the to-be-removed virtual prop to a backpack, for example, return the to-be-removed virtual prop A2 corresponding to the second virtual object 802 to the backpack. In some other embodiments, the terminal may automatically keep the remaining to-be-removed virtual prop on the first virtual object, for example, keep the remaining to-be-removed virtual prop C1 on the first virtual object 801. In another embodiment, the terminal may further automatically transfer the to-be-removed virtual prop corresponding to the second virtual object to the first virtual object, for example, transfer the to-be-removed virtual prop A2 corresponding to the second virtual object 802 to the first virtual object 801. In this embodiment, through the adjustment operation on the virtual props in the first prop region and the second prop region in the prop selection bar, the virtual prop with which the second virtual object is to be equipped and the to-be-removed virtual prop may be manually adjusted, so that the virtual prop can be more accurately equipped or removed while improving operation efficiency.

During the batch operation on the virtual prop of the first virtual object, the game player may intend not to transfer the virtual prop, but only to remove the virtual prop with which the first virtual object is equipped.

In some embodiments, when a third operation on the batch operation control is received, the virtual prop with which the first virtual object is equipped is removed.

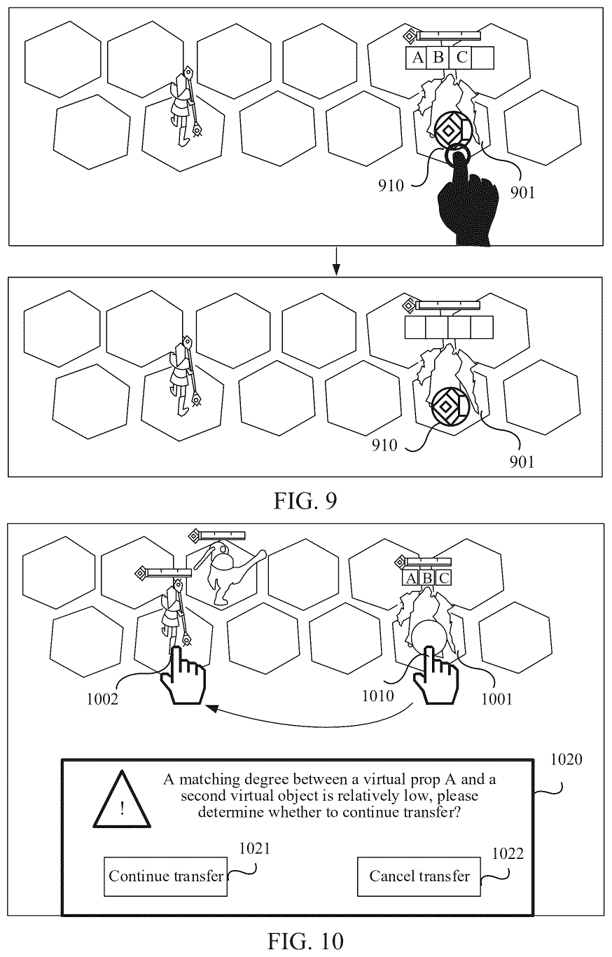

FIG. 9 is a schematic diagram of removing a virtual prop with which a first virtual object is equipped through a third operation according to an exemplary embodiment of this application.

As shown in FIG. 9, before the third trigger operation, the game interface includes a first virtual object 901 and a corresponding batch operation control 910. The first virtual object 901 is equipped with virtual props A, B, and C.

In response to the third operation, the virtual props A, B, and C with which the first virtual object 901 is equipped are removed. Therefore, after the third operation, the first virtual object 901 is not equipped with a virtual prop. The removed virtual props A, B, and C are returned to the backpack.

In some embodiments, the third operation is a clicking/tapping operation or a long-pressing operation. The third trigger operation may alternatively be another trigger operation type (different from the second operation), which is not limited in this embodiment of this application.

In this embodiment, through the third operation, the virtual prop with which the first virtual object is equipped may be efficiently removed, which improves operation efficiency of the game player.

In a process of transferring the virtual prop of the first virtual object to the second virtual object in batches, the virtual prop of the first virtual object and the second virtual object may have different matching degrees. For example, the virtual prop may be inapplicable (or particularly applicable) to a character type of the second virtual object. Alternatively, the virtual prop may be inapplicable (or particularly applicable) to a character level of the second virtual object. Therefore, the terminal may prompt, based on the matching degree between the virtual prop and the second virtual object, before batch transfer is performed on the virtual prop, to reduce a probability of false prop transfer.

In some embodiments, when a second operation on the batch operation control is received and an operation target indicated by the second operation is the second virtual object, the terminal determines the matching degree between the virtual prop with which the first virtual object is equipped and the second virtual object.

In some embodiments, the matching degree is determined based on an object attribute such as a character type or a character level of the second virtual object and a prop attribute of the virtual prop. For example, if the character type of the second virtual object is wizard, a legal virtual prop such as a mana crystal or an arcane staff has a relatively high matching degree with the wizard, and a physical virtual prop such as a fold dagger has a relatively low matching degree with the wizard.

In some embodiments, the matching degree is determined based on historical preference of the game player. For example, statistics may be collected on a frequency at which the game player sets a virtual prop with which the second virtual object is historically equipped, and a matching degree is also relatively high when the frequency is relatively high. In some embodiments, the terminal collects statistics about equipping frequencies of the virtual object for different virtual props, and normalizes equipping frequencies of different virtual props, so as to determine the matching degree between each virtual prop and the virtual object based on the normalized equipping frequencies.

In a possible scenario, when the matching degree between the virtual prop and the second virtual object is greater than a matching degree threshold, the terminal transfers the virtual prop in which the first virtual object is equipped to the second virtual object, and the terminal does not display a transfer confirmation prompt.

In another possible scenario, the terminal displays the transfer confirmation prompt when the matching degree between the virtual prop and the second virtual object is less than the matching degree threshold. The terminal transfers, in response to a confirmation operation on the transfer confirmation prompt, the virtual prop with which the first virtual object is equipped to the second virtual object. The terminal keeps, in response to a cancel operation on the transfer confirmation prompt, the virtual prop with which the first virtual object is equipped.

FIG. 10 is a schematic diagram of a transfer confirmation prompt according to an exemplary embodiment of this application.

As shown in FIG. 10, a game player performs a dragging operation on a batch operation control 1010, intending to transfer virtual props A, B, and C with which a first virtual object 1001 is equipped to a second virtual object 1002.

In a case that a matching degree between the virtual prop A and the second virtual object 1002 is less than a matching degree threshold (for example, 50%), the terminal displays a transfer confirmation prompt 1020 on a game interface. The transfer confirmation prompt 1020 includes text “The matching degree between the virtual prop A and the second virtual object is relatively low, please determine whether to continue transfer?”, to prompt the game player to further select a “continue transfer” control 1021 or a “Cancel Transfer” control 1022.

In response to a confirmation operation of the game player on the transfer confirmation prompt 1020 (for example, clicking/tapping the “Continue Transfer” control 1021), the virtual props A, B, and C with which the first virtual object 1001 is equipped are transferred to the second virtual object 1002.

In response to a cancel operation of the game player on the transfer confirmation prompt 1020 (for example, clicking/tapping the “Cancel Transfer” control 1022), the virtual props A, B, and C with which the first virtual object 1001 is equipped are kept.

After the game player performs the cancel operation on the transfer confirmation prompt 1020, in a possible implementation, the game player may retransfer the virtual prop equipped with the first virtual object 1001 to the second virtual object 1002 in batches based on a prop selection bar or the like, and remove the virtual prop A in the prop selection bar based on an adjustment operation.

In this embodiment, in a process of transferring the virtual prop in batches, when the virtual prop with which the first virtual object is equipped has a relatively low matching degree with the second virtual object, reference may be provided for a virtual prop transfer behavior of the game player by displaying a transfer confirmation prompt, to avoid false transfer of a virtual prop having a relatively low matching degree, thereby improving accuracy of the batch transfer.

Regarding an arrangement position of the batch operation control, in some embodiments, the batch operation control may be placed on a peripheral side of the first virtual object. In some other embodiments, the batch operation control is placed in an object information panel corresponding to the first virtual object.

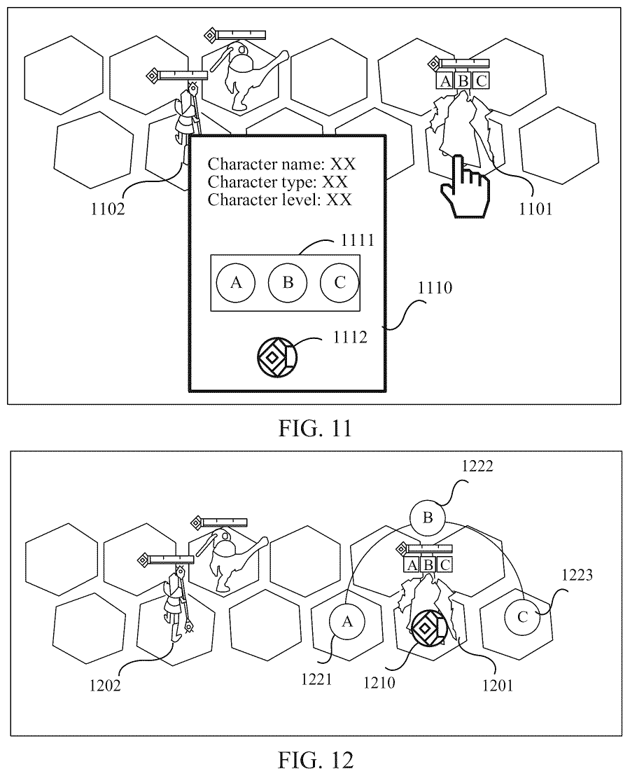

FIG. 11 is a schematic diagram of displaying a prop identifier of a virtual prop and a batch operation control in an object information panel of a first virtual object according to an exemplary embodiment of this application.

As shown in FIG. 11, a first virtual object 1101 is equipped with virtual props A, B, and C. In response to a first trigger operation (such as a touching and holding operation) on the first virtual object 1101, a terminal displays an object information panel 1110 of the first virtual object 1101.

In some embodiments, prop identifiers, such as a prop identifier 1111, of the virtual props A, B, and C are displayed in the object information panel 1110, to display virtual props with which the first virtual object 1101 is equipped to a game player.

In some embodiments, when a quantity of prop with which the first virtual object 1101 is equipped is greater than a first quantity, a batch operation control 1112 is displayed in the object information panel 1110. The batch operation control 1112 is configured to trigger a batch operation on the virtual prop with which the first virtual object 1101 is equipped.

For example, the game player may move the batch operation control 1112 to the second virtual object 1102 through a dragging operation, to transfer the virtual prop of the first virtual object 1101 to the second virtual object 1102 in batches.

In some embodiments, the terminal displays the object information panel not including the batch operation control when the first operation on the first virtual object is received and the quantity of props with which the first virtual object is equipped is less than the first quantity. For example, only the prop identifier 1111 is displayed in the object information panel 1110, and the batch operation control 1112 is not displayed. The game player may independently drag a prop identifier corresponding to any virtual prop in the prop identifier 1111, to independently transfer the virtual prop.

FIG. 12 is a schematic diagram of displaying a prop identifier of a virtual prop and a batch operation control on a peripheral side of the first virtual object according to an exemplary embodiment of this application.

As shown in FIG. 12, a first virtual object 1201 is equipped with virtual props A, B, and C.

The terminal displays a batch operation control 1210 and a prop identifier of the virtual prop on a peripheral side of the first virtual object 1201 when a first operation (such as a touching and holding operation) on the first virtual object 1201 is received and a quantity of props with which the first virtual object is equipped is greater than a first quantity.

The prop identifier of the virtual prop may include a prop identifier 1221 of a virtual prop A, a prop identifier 1222 of a virtual prop B, and a prop identifier 1223 of a virtual prop C.

In some embodiments, a game player may move the batch operation control 1210 to the second virtual object 1202 through a dragging operation, to transfer a virtual prop of the first virtual object 1201 to the second virtual object 1202 in batches.

In some embodiments, the terminal displays, when the first operation on the first virtual object is received and the quantity of props with which the first virtual object is equipped is less than the first quantity, the prop identifier of the virtual prop on the peripheral side of the first virtual object instead of displaying the batch operation control.

In some embodiments, the prop identifier of the virtual prop may be configured to implement transfer of a single virtual prop. For example, the terminal receives an independent dragging operation of the game player on the prop identifier 1221 of the virtual prop A, and independently transfers the virtual prop A from the first virtual object 1201 to the second virtual object 1202.

In some embodiments, the batch operation control may further be arranged at another possible position on a game interface, for example, fixedly arranged at an upper right corner of the game interface, or arranged at a dedicated panel for managing the virtual prop. A specific arrangement manner of the batch operation control is not limited in this embodiment of this application.

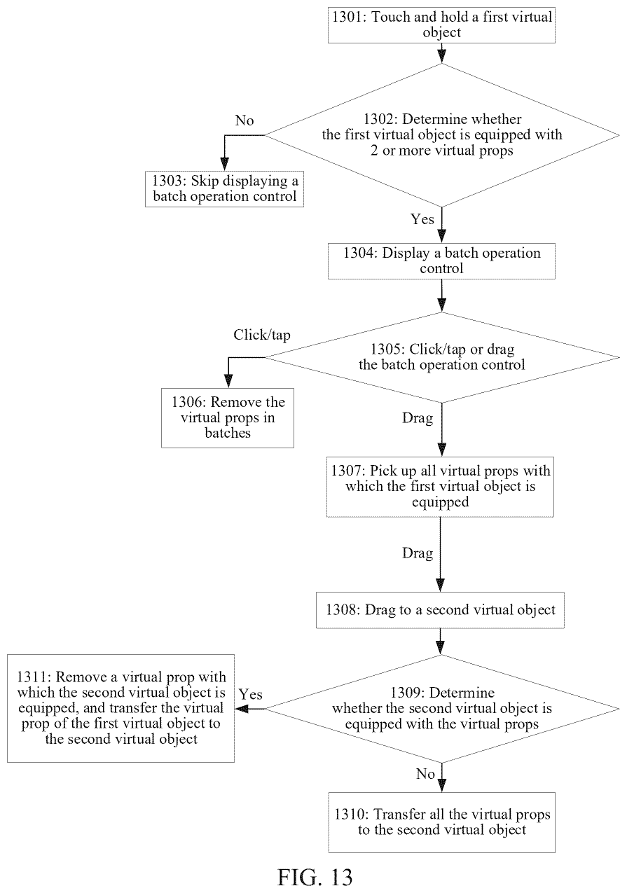

FIG. 13 is a flowchart of an operation method for a virtual prop according to an exemplary embodiment of this application. The flowchart includes the following operations.

Operation 1301: Touch and hold on a first virtual object.

The touching and holding may be the first operation described in the foregoing embodiments.

Operation 1302: Determine whether the first virtual object is equipped with 2 or more virtual props.

In some embodiments, a quantity of prop equipment is calculated based on the virtual props in the object information panel of the first virtual object, and then whether the quantity of prop equipment is 2 or more is determined.

If the first virtual object is not equipped with 2 or more virtual props, operation 1303 is performed, namely, skip displaying a batch operation control.

Operation 1304 is performed when the first virtual object is equipped with 2 or more virtual props.

Operation 1304: Display the batch operation control.

The batch operation control is configured to trigger a batch operation on the virtual prop with which the first virtual object is equipped.

In some embodiments, the terminal may display the batch operation control on a peripheral side of the first virtual object on a game interface.

In some other embodiments, the terminal may display the batch operation control in the object information panel of the first virtual object.

Operation 1305: Click/tap or drag the batch operation control.

The dragging may be the second operation in the foregoing embodiment, and the clicking may be the third operation in the foregoing embodiment.

If the operation on the batch operation control is a click/tap, operation 1306 is performed, i.e., remove the virtual props in batches.

In a case that the operation on the batch operation control is dragging, operation 1307 of picking up all virtual props with which the first virtual object is equipped is performed.

In some embodiments, while all virtual props of the first virtual object equipment are picked up, prop thumbnail identifiers of the virtual props are displayed on the peripheral side of the first virtual object.

Operation 1308: Drag the batch operation control to a second virtual object.

Operation 1309: Determine whether the second virtual object is equipped with the virtual props.

In a case that the second virtual object is not equipped with the virtual prop, operation 1310 is performed, namely, transfer all the virtual props of the first virtual object to the second virtual object.

Operation 1311 is performed when the second virtual object is equipped with the virtual prop.

Operation 1311: Remove a virtual prop with which the second virtual object is equipped, and transfer the virtual prop of the first virtual object to the second virtual object.

In some embodiments, all virtual props with which the second virtual object is equipped are removed, and all virtual props of the first virtual object are transferred to the second virtual object.

In some embodiments, when the first virtual object and the second virtual object are both equipped with a virtual prop of a target type, the virtual prop of the target type with which the second virtual object is equipped is determined as the target virtual prop. The target virtual prop is removed, and all virtual props of the first virtual object are transferred to the second virtual object.

In some embodiments, a to-be-removed virtual prop corresponding to the second virtual object and a to-be-transferred virtual prop corresponding to the first virtual object are determined through a prop selection bar based on an adjustment operation of the game player. The to-be-removed virtual prop corresponding to the second virtual object is removed, and the to-be-transferred virtual prop corresponding to the first virtual object is transferred to the second virtual object.

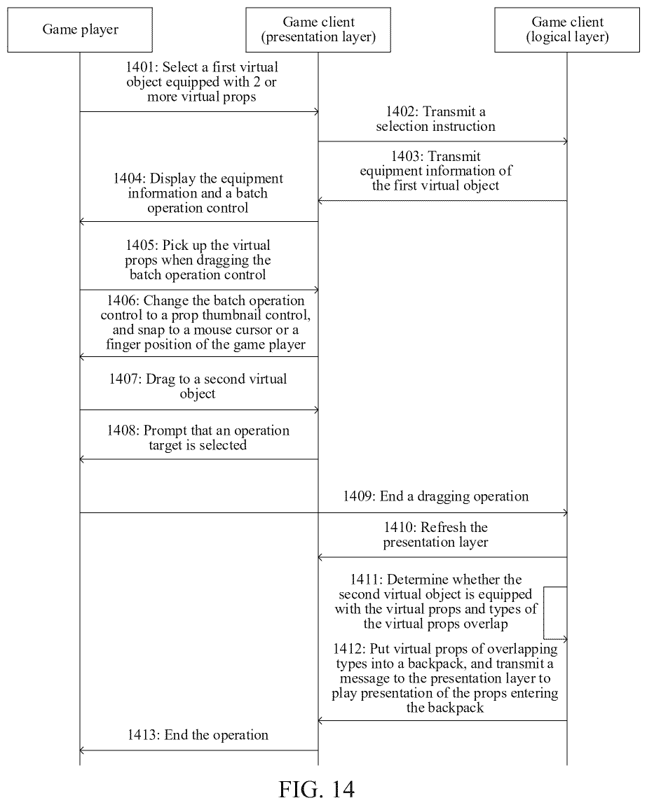

FIG. 14 is a timing diagram of an operation method for a virtual prop according to an exemplary embodiment of this application. The time sequence diagram reflects a time sequence data interaction relationship among a game player, a game client (a presentation layer), and a game client (a logical layer). The sequence diagram includes the following operations.

Operation 1401: The game player selects a first virtual object equipped with 2 or more virtual props.

Operation 1402: The game client (the presentation layer) transmits a selection instruction corresponding to a selection operation to the game client (the logical layer).

Operation 1403: The game client (the logical layer) invokes equipment information of the first virtual object based on the selection instruction, and transmits the equipment information to the game client (the presentation layer).

Operation 1404: The game client (the presentation layer) receives the equipment information of the first virtual object, and displays the equipment information of the first virtual object and a batch operation control to the game player.

In some embodiments, the game client (the presentation layer) may display the equipment information and the batch operation control of the first virtual object on a peripheral side of the first virtual object or on an object information panel.

Operation 1405: The game player picks up the virtual props when dragging the batch operation control.

Operation 1406: The game client (the presentation layer) changes the batch operation control to a prop thumbnail control, and the prop thumbnail control is snapped to a mouse cursor or a finger position of the game player in a dragging process of the game player.

Operation 1407: The game player drags the prop thumbnail control to the second virtual object.

Operation 1408: The game client (the presentation layer) prompts the game player that an operation target is selected.

In some embodiments, the game client (the presentation layer) displays a prompt for transferring the virtual prop to the second virtual object, to inform the game player that the operation target is selected.

Operation 1409: The game player ends the dragging operation in a manner such as loosening the mouse cursor or the finger.

Operation 1410: The game client (the logical layer) receives an execution instruction of ending the dragging operation from the game player, transfers the virtual prop to the second virtual object, and transmits a refresh instruction to the game client (the presentation layer), so that the game client (the presentation layer) refreshes a corresponding page presentation.

Operation 1411: The game client (the logical layer) invokes the equipment information of the second virtual object, to determine whether the second virtual object is equipped with the virtual prop, and whether a type of the virtual prop of the second virtual object overlaps with that of the first virtual object.

Operation 1412: The game client (the logical layer) puts the virtual prop into the backpack if the type of the virtual prop of the second virtual object overlaps with that of the first virtual object; meanwhile, the game client (the logical layer) transmits a message to the game client (the presentation layer), so that the game client (the presentation layer) plays presentation of the virtual prop entering the backpack.

Operation 1413: End the operation.

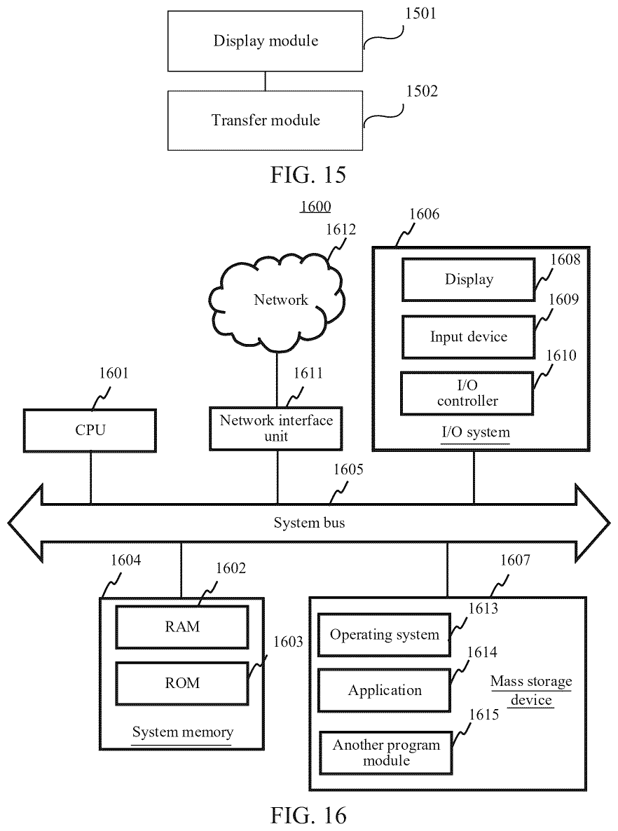

FIG. 15 is a structural block diagram of an operation apparatus for a virtual prop according to an exemplary embodiment of this application. The apparatus includes: a display module 1501, configured to display a first virtual object, the first virtual object being equipped with a virtual prop;

the display module 1501 being further configured to display a batch operation control when a first operation on the first virtual object is received and a quantity of props with which the first virtual object is equipped is greater than a first quantity, the batch operation control being configured to trigger a batch operation on the virtual prop with which the first virtual object is equipped, and the first quantity being a positive integer; and a transfer module 1502, configured to transfer, when a second operation on the batch operation control is received and an operation target indicated by the second operation is a second virtual object, the virtual prop with which the first virtual object is equipped to the second virtual object.

In some embodiments, the second operation is a dragging operation. The transfer module 1502 is configured to:
transfer, to the second virtual object, the virtual prop with which the first virtual object is equipped when the dragging operation on the batch operation control is received and a dragging end point of the dragging operation is located on the second virtual object.

In some embodiments, before the transferring the virtual prop with which the first virtual object is equipped to the second virtual object, the transfer module 1502 is configured to:
change the batch operation control to a prop thumbnail control when the dragging operation on the batch operation control is received, a prop thumbnail identifier of the virtual prop with which the first virtual object is equipped being displayed in the prop thumbnail control, and the prop thumbnail control moving with the dragging operation; and
display a prop transfer prompt when a dragging position of the dragging operation is located on the second virtual object, the prop transfer prompt including a first object identifier of the first virtual object, a second object identifier of the second virtual object, and the prop thumbnail identifier.

In some embodiments, the transfer module 1502 is configured to:
display the prop transfer prompt when the dragging position of the dragging operation is located on the second virtual object and the second virtual object is supported in equipping a virtual prop.

In some embodiments, the transfer module 1502 is configured to:
display a transfer prohibition prompt when the dragging position of the dragging operation is located on the second virtual object and the second virtual object is not supported in equipping the virtual prop.

In some embodiments, keeping the virtual prop with which the first virtual object is equipped when the dragging operation on the batch operation control is received and no virtual object exists at the dragging end point of the dragging operation, or the virtual object at the dragging end point is not supported in equipping the virtual prop.

In some embodiments, before the transferring the virtual prop with which the first virtual object is equipped to the second virtual object, the transfer module 1502 is configured to:
remove, based on the virtual props with which the first virtual object and the second virtual object are equipped when the second virtual object is equipped with the virtual prop, a target virtual prop with which the second virtual object is equipped.

In some embodiments, the transfer module 1502 is configured to:
determine, when the first virtual object and the second virtual object are both equipped with a virtual prop of a target type, the virtual prop of the target type with which the second virtual object is equipped as the target virtual prop; and
remove the target virtual prop.

In some embodiments, the transfer module 1502 is configured to: transfer the target virtual prop to the first virtual object.

In some embodiments, before the transferring the virtual prop with which the first virtual object is equipped to the second virtual object, the transfer module 1502 is configured to:
display a prop selection bar when the second virtual object is equipped with the virtual prop, the prop selection bar including a first prop region and a second prop region, the first prop region being configured to display a to-be-removed virtual prop, the second prop region being configured to display a virtual prop with which the second virtual object is to be equipped, and the virtual props with which the first virtual object and the second virtual object are equipped being initially displayed in the second prop region;
determine, in response to an adjustment operation on the virtual props in the first prop region and the second prop region, the virtual prop with which the second virtual object is to be equipped;
determine a to-be-removed virtual prop corresponding to the second virtual object and a to-be-transferred virtual prop corresponding to the first virtual object based on the virtual prop with which the second virtual object is to be equipped and the virtual props with which the first virtual object and the second virtual object are currently equipped; and
remove the to-be-removed virtual prop corresponding to the second virtual object.

The transferring the virtual prop with which the first virtual object is equipped to the second virtual object includes:
transferring the to-be-transferred virtual prop corresponding to the first virtual object to the second virtual object.

In some embodiments, removing the virtual prop with which the first virtual object is equipped when a third operation on the batch operation control is received.

In some embodiments, the transfer module 1502 is configured to:
determine, when the second operation on the batch operation control is received and an operation target indicated by the second operation is the second virtual object, a matching degree between the virtual prop with which the first virtual object is equipped and the second virtual object; and
transfer, to the second virtual object, the virtual prop with which the first virtual object is equipped when the matching degree is greater than a matching degree threshold.

In some embodiments, the transfer module 1502 is configured to:
display a transfer confirmation prompt when the matching degree is less than the matching degree threshold;
transfer, in response to a confirmation operation on the transfer confirmation prompt, the virtual prop with which the first virtual object is equipped to the second virtual object; and
keep, in response to a cancel operation on the transfer confirmation prompt, the virtual prop with which the first virtual object is equipped.

In some embodiments, the display module 1501 is configured to:
display, in response to the first operation on the first virtual object, an object information panel of the first virtual object, a prop identifier of the virtual prop being displayed in the object information panel; display the batch operation control in the object information panel when the quantity of props with which the first virtual object is equipped is greater than the first quantity; or
display the prop identifier of the virtual prop and the batch operation control on a peripheral side of the first virtual object when the first operation on the first virtual object is received and the quantity of props with which the first virtual object is equipped is greater than the first quantity.

In some embodiments, the display module 1501 is configured to:
display the object information panel not including the batch operation control when the first operation on the first virtual object is received and the quantity of props with which the first virtual object is equipped is less than the first quantity; or
display the prop identifier of the virtual prop on a peripheral side of the first virtual object when the first operation on the first virtual object is received and the quantity of props with which the first virtual object is equipped is less than the first quantity.

FIG. 16 is a schematic structural diagram of a terminal according to an exemplary embodiment of this application.

In some embodiments, a terminal 1600 is a smart phone, a tablet computer, a notebook computer, or a desktop computer. The terminal may also be referred to as another name such as user device, a portable terminal, a laptop terminal, or a desktop terminal.

Specifically, the terminal 1600 includes a central processing unit (CPU) 1601, a system memory 1604 including a random access memory (RAM) 1602 and a read-only memory (ROM) 1603, and a system bus 1605 connected to the system memory 1604 to the CPU 1601. The terminal 1600 further includes a basic input/output (I/O) system 1606 for facilitating information transmission between devices in a computer, and a mass storage device 1607 configured to store an operating system 1613, an application 1614, and another program module 1615.

The basic I/O system 1606 includes a display 1608 configured to display information and an input device 1609 such as a mouse or a keyboard for a user to input information. The display 1608 and the input device 1609 are both connected to the CPU 1601 through an I/O controller 1610 connected to the system bus 1605. The basic I/O system 1606 may further include the I/O controller 1610 to receive and process inputs from a plurality of other devices such as a keyboard, a mouse, or an electronic stylus. Similarly, the I/O controller 1610 further provides an output to a display screen, a printer, or another type of output device.

The mass storage device 1607 is connected to the CPU 1601 through a mass storage controller (not shown) connected to the system bus 1605. The mass storage device 1607 and an associated computer-readable medium thereof provide non-volatile storage for the terminal 1600. In other words, the mass storage device 1607 may include a computer-readable medium (not shown) such as a hard disk or a drive.

Without loss of generality, the computer-readable medium may include a computer storage medium and a communication medium. The computer storage medium includes volatile and non-volatile media, and removable and non-removable media implemented by using any method or technology used for storing information such as computer-readable instructions, data structures, program modules, or other data. The computer storage medium includes the RAM, the ROM, a flash memory or another solid-state memory, a compact disc read-only memory (CD-ROM), a digital versatile disc (DVD) or another optical memory, a magnetic cassette, a magnetic tape, a disk memory, or another magnetic storage device. Certainly, a person skilled in the art may learn that the computer storage medium is not limited to the foregoing several types. The foregoing system memory 1604 and the mass storage device 1607 may be collectively referred to as a memory.

The memory has one or more programs stored therein, the one or more programs being configured to be executed by one or more CPUs 1601, and the one or more programs including instructions for implementing the foregoing method. The CPU 1601 executes the one or more programs to implement the method provided in the foregoing method embodiments.

According to various embodiments of this application, the terminal 1600 may be further connected to a remote computer on a network for running through a network such as the Internet. In other words, the terminal 1600 may be connected to a network 1612 through a network interface unit 1611 connected to the system bus 1605, or may be connected to other types of networks or remote computer systems (not shown) through the network interface unit 1611.

The memory further includes one or more programs, the one or more programs being stored in the memory and including operations to be performed by the computer device for performing the method provided in the embodiments of this application.

An embodiment of this application further provides a non-transitory computer-readable storage medium, having at least one computer instruction stored therein, the at least one computer instruction being loaded and executed by a processor to implement the method provided in any of the foregoing embodiments.

In some embodiments, the computer-readable storage medium may include a ROM, a RAM, a solid state drive (SSD), an optical disc, and the like. The RAM may include a resistance random access memory (ReRAM) and a dynamic random access memory (DRAM).

An embodiment of this application provides a computer program product, including a computer instruction, the computer instruction being stored in a non-transitory computer-readable storage medium. A processor of a computer device reads the computer instruction from the computer-readable storage medium, and the processor executes the computer instruction, so that the computer device performs the method in the foregoing method embodiments.

A person of ordinary skill in the art may understand that all or part of the operations of implementing the foregoing embodiments may be implemented by hardware, or may be implemented by a program instructing related hardware. The program may be stored in a non-transitory computer-readable storage medium. The storage medium mentioned above may be a ROM, a magnetic disk, an optical disc, or the like.

The foregoing descriptions are merely exemplary embodiments of this application, but are not intended to limit this application. Any modification, equivalent replacement, or improvement made within the spirit and principle of this application shall fall within the protection scope of this application. In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module.

What is claimed is:

1. A method for operating a virtual prop performed by a computer device, the method comprising:
displaying a first virtual object;
displaying a batch operation control when a first operation on the first virtual object is received and a quantity of props with which the first virtual object is equipped is greater than a first quantity; and
when a second operation on the batch operation control is received and an operation target indicated by the second operation is a second virtual object, transferring the virtual props with which the first virtual object is equipped to the second virtual object.

2. The method according to claim 1, wherein the second operation is a dragging operation; and
the transferring the virtual props with which the first virtual object is equipped to the second virtual object comprises:
transferring, to the second virtual object, the virtual props with which the first virtual object is equipped when the dragging operation on the batch operation control is received and a dragging end point of the dragging operation is located on the second virtual object.

3. The method according to claim 2, wherein before the transferring the virtual props with which the first virtual object is equipped to the second virtual object, the method further comprises:
changing the batch operation control to a prop thumbnail control when the dragging operation on the batch operation control is received and the prop thumbnail control moving with the dragging operation; and
displaying a prop transfer prompt when a dragging position of the dragging operation is located on the second virtual object, the prop transfer prompt comprising a first object identifier of the first virtual object, a second object identifier of the second virtual object, and a prop thumbnail identifier of the virtual props with which the first virtual object is equipped.

4. The method according to claim 3, wherein the displaying a prop transfer prompt when a dragging position of the dragging operation is located on the second virtual object comprises:
displaying the prop transfer prompt when the dragging position of the dragging operation is located on the second virtual object and the second virtual object is supported in equipping a virtual prop; and
displaying a transfer prohibition prompt when the dragging position of the dragging operation is located on the second virtual object and the second virtual object is not supported in equipping the virtual prop.

5. The method according to claim 2, further comprising:
keeping the virtual props with which the first virtual object is equipped when the dragging operation on the batch operation control is received and no virtual object exists at the dragging end point of the dragging operation, or the virtual object at the dragging end point is not supported in equipping the virtual props.

6. The method according to claim 1, wherein before the transferring the virtual props with which the first virtual object is equipped to the second virtual object, the method further comprises:
removing, based on the virtual props with which the first virtual object and the second virtual object are equipped when the second virtual object is equipped with the virtual prop, a target virtual prop with which the second virtual object is equipped.

7. The method according to claim 6, further comprising:
transferring the target virtual prop to the first virtual object.

8. The method according to claim 1, further comprising:
removing the virtual props with which the first virtual object is equipped when a third operation on the batch operation control is received.

9. The method according to claim 1, wherein the transferring the virtual props with which the first virtual object is equipped to the second virtual object comprises:
when the second operation on the batch operation control is received and an operation target indicated by the second operation is the second virtual object, determining a matching degree between the virtual props with which the first virtual object is equipped and the second virtual object;
when the matching degree is greater than a matching degree threshold, transferring, to the second virtual object, the virtual props with which the first virtual object is equipped;
when the matching degree is less than the matching degree threshold, displaying a transfer confirmation prompt;
in response to a confirmation operation on the transfer confirmation prompt, transferring the virtual props with which the first virtual object is equipped to the second virtual object.

10. The method according to claim 1, wherein the displaying a batch operation control when a first operation on the first virtual object is received and a quantity of props with which the first virtual object is equipped is greater than a first quantity comprises:
displaying, in response to the first operation on the first virtual object, an object information panel of the first virtual object, a prop identifier of the virtual prop being displayed in the object information panel; displaying the batch operation control in the object information panel when the quantity of props with which the first virtual object is equipped is greater than the first quantity; or
displaying the prop identifier of the virtual prop and the batch operation control on a peripheral side of the first virtual object when the first operation on the first virtual object is received and the quantity of props with which the first virtual object is equipped is greater than the first quantity.

11. The method according to claim 10, further comprising:
displaying the object information panel not comprising the batch operation control when the first operation on the first virtual object is received and the quantity of props with which the first virtual object is equipped is less than the first quantity; or
displaying the prop identifier of the virtual prop on a peripheral side of the first virtual object when the first operation on the first virtual object is received and the quantity of props with which the first virtual object is equipped is less than the first quantity.

12. A computer device, comprising a processor and a memory, the memory having at least one computer instruction stored therein, the at least one computer instruction, when executed by the processor, causing the computer device to implement a method for operating a virtual prop including:
displaying a first virtual object;
displaying a batch operation control when a first operation on the first virtual object is received and a quantity of props with which the first virtual object is equipped is greater than a first quantity; and
when a second operation on the batch operation control is received and an operation target indicated by the second operation is a second virtual object, transferring the virtual props with which the first virtual object is equipped to the second virtual object.

13. The computer device according to claim 12, wherein the second operation is a dragging operation; and
the transferring the virtual props with which the first virtual object is equipped to the second virtual object comprises:
transferring, to the second virtual object, the virtual props with which the first virtual object is equipped when the dragging operation on the batch operation control is received and a dragging end point of the dragging operation is located on the second virtual object.

14. The computer device according to claim 12, wherein before the transferring the virtual props with which the first virtual object is equipped to the second virtual object, the method further comprises:
removing, based on the virtual props with which the first virtual object and the second virtual object are equipped when the second virtual object is equipped with the virtual prop, a target virtual prop with which the second virtual object is equipped.

15. The computer device according to claim 12, wherein the method further comprises:
removing the virtual props with which the first virtual object is equipped when a third operation on the batch operation control is received.

16. The computer device according to claim 12, wherein the transferring the virtual props with which the first virtual object is equipped to the second virtual object comprises:
when the second operation on the batch operation control is received and an operation target indicated by the second operation is the second virtual object, determining a matching degree between the virtual props with which the first virtual object is equipped and the second virtual object;
when the matching degree is greater than a matching degree threshold, transferring, to the second virtual object, the virtual props with which the first virtual object is equipped;
when the matching degree is less than the matching degree threshold, displaying a transfer confirmation prompt;
in response to a confirmation operation on the transfer confirmation prompt, transferring the virtual props with which the first virtual object is equipped to the second virtual object.

17. The computer device according to claim 12, wherein the displaying a batch operation control when a first operation on the first virtual object is received and a quantity of props with which the first virtual object is equipped is greater than a first quantity comprises:
displaying, in response to the first operation on the first virtual object, an object information panel of the first virtual object, a prop identifier of the virtual prop being displayed in the object information panel; displaying the batch operation control in the object information panel when the quantity of props with which the first virtual object is equipped is greater than the first quantity; or
displaying the prop identifier of the virtual prop and the batch operation control on a peripheral side of the first virtual object when the first operation on the first virtual object is received and the quantity of props with which the first virtual object is equipped is greater than the first quantity.

18. A non-transitory computer-readable storage medium, having at least one computer instruction stored therein, the at least one computer instruction, when executed by a processor of a computer device, causing the computer device to implement a method for operating a virtual prop including:
displaying a first virtual object;
displaying a batch operation control when a first operation on the first virtual object is received and a quantity of props with which the first virtual object is equipped is greater than a first quantity; and
when a second operation on the batch operation control is received and an operation target indicated by the second operation is a second virtual object, transferring the virtual props with which the first virtual object is equipped to the second virtual object.

19. The storage medium according to claim 18, wherein the second operation is a dragging operation; and
the transferring the virtual props with which the first virtual object is equipped to the second virtual object comprises:
transferring, to the second virtual object, the virtual props with which the first virtual object is equipped when the dragging operation on the batch operation control is received and a dragging end point of the dragging operation is located on the second virtual object.

20. The storage medium according to claim 18, wherein before the transferring the virtual props with which the first virtual object is equipped to the second virtual object, the method further comprises:
removing, based on the virtual props with which the first virtual object and the second virtual object are equipped when the second virtual object is equipped with the virtual prop, a target virtual prop with which the second virtual object is equipped.
